(19) United States
(12) Patent Application Publication
(10) Pub. No.: US 2007/0143723 A1
(43) Pub. Date: Jun. 21, 2007

(54) Method of timing verification and layout optimization

(76) Inventor: Yoshiyuki Kawakami, Osaka (JP)

Correspondence Address: MCDERMOTT WILL & EMERY LLP, 600 13TH STREET, NW, WASHINGTON, DC, 20005-3096, US

(21) Appl. No.: 11/642,725

(22) Filed: Dec. 21, 2006

(30) Foreign Application Priority Data
Dec. 21, 2005 (JP) 2005-368573

(51) Int. Cl. G06F 17/50

(52) U.S. Cl. 716/6; 716/5

(57) ABSTRACT

In timing verification considering process variations in the fabrication of semiconductor integrated circuits, parasitic element extraction results are obtained with high accuracy by considering variations in interconnect configuration occurring randomly inside LSI to perform timing verification of worst-case or best-case simulation. For example, a plurality of capacitance libraries are prepared according to process variations in the fabrication of semiconductor integrated circuits, such as variations in interconnect width, interconnect film thickness and interlayer film thickness, and one is selected among these capacitance libraries properly according to the target layout. In this way, parasitic element extraction results for worst-case or best-case simulation can be obtained with high accuracy for the target layout.

### CROSS-REFERENCE TO RELATED APPLICATIONS

This non-provisional application claims priority under 35 U.S.C. §119(a) on Patent Application No. 2005-368573 filed in Japan on Dec. 21, 2005, the entire contents of which are hereby incorporated by reference.

### BACKGROUND OF THE INVENTION

The present invention relates to an effective timing verification method adopted when designing semiconductor integrated circuits considering variations in semiconductor fabrication process.

In recent years, in fabrication of semiconductor integrated circuits, the micro-machining technology for elements such as transistors and interconnects has made progress. With the elements becoming finer, the delay time of transistors included in logic cells decreases. Meanwhile, however, since the distance between interconnects becomes shorter and the width of interconnects becomes smaller, the capacitance between interconnects (inter-wire capacitance) and the interconnect resistance increase, causing increase of the delay time of interconnects. As a result, the proportion of the interconnect delay time in the entire delay time of a semiconductor integrated circuit increases. In consideration of this, it will become increasingly important in future to estimate the interconnect delay time correctly.

When operation timing is to be verified in designing of semiconductor integrated circuits, it is necessary to calculate the delay time considering machining variations in the process and variations in temperature, power supply voltage and the like. In other words, when timing verification considering the interconnect delay time is to be performed, it is necessary to calculate the interconnect resistance and the inter-wire capacitance by estimating variations in interconnect film thickness, interconnect width and interlayer film thickness and moreover variations in the dielectric constant of materials and the like, and calculate the interconnect delay time using the calculated interconnect resistance and inter-wire capacitance.

Under the circumstances described above, a circuit simulation technology is conventionally employed in which the interconnect resistance and the inter-wire capacitance are calculated based on the variation amount (process variation amount) of a process variation factor that varies at least one of the interconnect resistance and the inter-wire capacitance that are dependent on the fabrication process of the semiconductor integrated circuit.

For example, Japanese Laid-Open Patent Publication No. 2004-252831 (Patent Literature 1) discloses a method of performing timing simulation in which, using a circuit simulator simulating the circuit operation of logic cells constituting an LSI (semiconductor integrated circuit), delay information considering process variations based on process parameters and the like is statistically processed to prepare a statistic delay library having delay information of the logic cells, and the timing simulation is performed using the statistic delay library.

LSI-level timing verification (gate-level timing verification) generally includes worst-case simulation and best-case simulation. The worst-case simulation is a simulation assuming the case in which the LSI operation may be slowest depending on the process machining and the use conditions. The best-case simulation is the reverse to the worst-case simulation. A case giving slow circuit operation is assumed and stored in advance in a timing library having timing information of logic cells. Also, as interconnect information, resistance and capacitance values that may give the longest interconnect delay are prepared. By combining these cases, the worst-case simulation is realized. As such a simulation method, the following technology is conventionally known.

For example, in Japanese Laid-Open Patent Publication No. 2001-306647 (Patent Literature 2), a design parameter (for example, interconnect pattern width and interval, etc.) generated with a process variation factor is set for each condition, parasitic element extraction is performed based on the design parameter, and then delay calculation is made. The delay calculation results for all conditions obtained are integrated, and timing simulation is performed using the integrated results. This method requires combining a plurality of LPE results with the timing library for all the wiring variation conditions.

In Japanese Laid-Open Patent Publication No. 10-240796 (Patent Literature 3), a net list is produced from layout data. In the net list, parasitic element values are expressed as functions with process data (bottom capacitance per unit interconnect area, sheet resistance of interconnects, etc.) corresponding to the interconnect resistance, the interconnect capacitance and the like given as variables. Worst-case analysis is performed using such a net list. In other words, the variation range of a variable of each function-expressed parasitic element value is set in advance, and either the maximum or minimum value determined thereby is regarded as the representative value of the variable. The parasitic element value is calculated repeatedly by the number of combinations of such representative values by assigning the representative values to the variables, to thereby perform circuit simulation. In this method, the interconnect resistance and the interconnect capacitance can be calculated with high accuracy even considering variation conditions as long as the interconnect pattern is simple. However, if the interconnect pattern is complicated, such as when a plurality of interconnects exist around a target interconnect, it is difficult to express parasitic element values as functions. Moreover, although the calculation itself becomes complicated, the resultant interconnect resistance and interconnect capacitance are not necessarily highly accurate. To solve this problem, Japanese Laid-Open Patent Publication No. 2001-265826 (Patent Literature 4) presents a method in which the calculation is made considering the interconnect pattern in more detail.

In the simulation method in Patent Literature 4, variations in the capacitance of a target interconnect considering the target interconnect and a side interconnect and a crossing interconnect existing around the target interconnect are not obtained by simply varying an argument of a function. Instead, an interconnect structure considering variation conditions including surrounding interconnects existing around the target interconnect is produced, and the interconnect capacitance is calculated from this interconnect structure. In this way, highly accurate interconnect capacitance considering variations in fabrication process steps can be extracted.

However, the conventional circuit simulation described above has a drawback, which will be discussed below in a concrete manner.

It is generally difficult to obtain the resistance value and capacitance value that give the longest interconnect delay required in performing worst-case simulation. The reason is as follows. The conditions giving a large resistance value are that the interconnect width is small and the interconnect film thickness is small. Under these conditions, the capacitance value is small. In reverse, the conditions giving a large capacitance value are that the interconnect width is large and the interlayer film thickness is small. Under these conditions, the resistance value is small. Hence, since it is not allowed to increase the resistance value and the capacitance value simultaneously, a situation giving a large delay must be found while considering a balance between these values. The capacitance value and the resistance value vary among interconnect nets in an LSI. Therefore, in the conventional circuit simulation method described above, a huge processing time will be necessary to obtain a balance between the resistance value and the capacitance value at which the delay is largest for the respective interconnect nets.

### SUMMARY OF THE INVENTION

An object of the present invention is providing a timing verification method in which worst-case simulation and best-case simulation can be performed with high accuracy in a short time.

To attain the above object, in a timing verification method according to the present invention, a plurality of capacitance libraries are prepared in advance under the conditions of combinations of variation parameters (such as the interconnect width, the interconnect film thickness and the interlayer film thickness, for example) that may cause interconnect delay variations originating from process variations in the fabrication of semiconductor integrated circuits, so that conditions for worst-case or best-case simulation obtained when the above respective variation parameters vary can be determined. Using the plurality of capacitance libraries, parasitic elements are repeatedly extracted, and any one of the extraction results of parasitic elements is selectively used, to thereby permit condition-specific timing verification. For example, assuming that there exist three types of variation parameters, that is, the interconnect width, the interconnect film thickness and the interlayer film thickness, at least the third power of 2 (=8) capacitance libraries are prepared in advance.

In relation to the above, attention should be given to the point that it is possible to maximize either one of the inter-wire capacitance and the interconnect resistance. For example, in a long interconnect, it is easily presumed that the delay of the interconnect is greater as the resistance thereof is greater. In a short interconnect, on the other hand, the interconnect delay may be greatest when the capacitance is greatest. In any case, the worst case of interconnect delay will be roughly obtainable if only which is the cause of increasing the interconnect delay, the resistance or the capacitance, is known. In other words, if the resistance is the main cause of increasing the interconnect delay, parasitic element extraction may be made assuming a situation that the interconnect width is small and the interconnect film thickness is small in which the resistance is the maximum. Contrarily, if the capacitance is the main cause, a situation that the interconnect width is large and the interconnect film thickness is large may be assumed. In this way, when either one of the resistance and the capacitance is the main cause of the interconnect delay, it is unnecessary to prepare a plurality of capacitance libraries, but preparation of only one capacitance library is enough.

To attain the above object, according to the present invention, for achievement of worst-case simulation and best-case simulation, one capacitance library is selected among a plurality of capacitance libraries prepared in advance considering the surrounding circumstances of an interconnect net for which capacitance extraction is to be made, to obtain a parasitic element extraction result. This processing is repeatedly performed, to thereby realize timing verification considering fabrication process variations.

Specifically, the timing verification method of the present invention is a timing verification method for verifying operation timing of a semiconductor integrated circuit including a plurality of cells having logic function, terminals of the plurality of cells being connected to each other via interconnects, the method including the steps of: preparing in advance a plurality of capacitance libraries made out based on a plurality of previously defined interconnect structures; and in extraction of parasitic element parameters such as resistance and capacitance in an interconnect pattern comprising a plurality of equipotential nets for connecting terminals of the plurality of cells to each other equipotentially, repeating calculating a parasitic element parameter for each of a plurality of conductors constituting one of the plurality of equipotential nets by selecting one of the plurality of capacitance libraries according to the state of another interconnect surrounding each conductor of the equipotential net; and repeating the calculation of the parasitic element parameter for each conductor of the one equipotential net for all the equipotential nets existing in the interconnect pattern.

According to the present invention, for achievement of worst-case simulation and best-case simulation, a plurality of capacitance libraries are prepared. One parasitic element extraction result is selected from a plurality of parasitic element extraction results obtained using the plurality of capacitance libraries, to be used as a new parasitic element extraction result. In this way, timing verification considering fabrication process variations is realized.

Specifically, the timing verification method of the present invention is a timing verification method for verifying operation timing of a semiconductor integrated circuit including a plurality of cells having logic function, terminals of the plurality of cells being connected to each other via interconnects, the method including the steps of: preparing in advance a plurality of capacitance libraries made out based on a plurality of previously defined interconnect structures; and in extraction of parasitic element parameters such as resistance and capacitance in an interconnect pattern comprising a plurality of equipotential nets for connecting terminals of the plurality of cells to each other equipotentially, calculating a parasitic element parameter using each of the plurality of capacitance libraries for one of the plurality of equipotential nets; selecting one of the plurality of calculated parasitic element parameters; and repeating the calculation and selection of the parasitic element parameters for one equipotential net for all the equipotential nets existing in the interconnect pattern.

According to the present invention, for achievement of worst-case simulation and best-case simulation, a plurality of capacitance libraries are prepared. One parasitic element extraction result is selected from a plurality of parasitic element extraction results obtained using the plurality of capacitance libraries. In this regard, one parasitic element extraction result is defined in advance as a reference interconnect network, and a capacitance value and resistance value included in the selected parasitic element extraction result are calculated in advance in the form of a ratio with respect to those in the defined reference interconnect network. In this way, timing verification considering fabrication process variations is realized.

Specifically, the timing verification method of the present invention is a timing verification method for verifying operation timing of a semiconductor integrated circuit including a plurality of cells having logic function, terminals of the plurality of cells being connected to each other via interconnects, the method including the steps of: preparing in advance a plurality of capacitance libraries made out based on a plurality of previously defined interconnect structures; and in extraction of parasitic element parameters such as resistance and capacitance in an interconnect pattern comprising a plurality of equipotential nets for connecting terminals of the plurality of cells to each other equipotentially, selecting one capacitance library among the plurality of capacitance libraries and calculating a parasitic element parameter using the selected capacitance library for one equipotential net selected from the plurality of equipotential nets to use the calculated parasitic element parameter as a reference parasitic element parameter; calculating parasitic element parameters using capacitance libraries other than the selected one capacitance library for the selected one equipotential net; selecting one of the plurality of parasitic element parameters calculated using the other capacitance libraries, and expressing the selected parasitic element parameter using the ratio of the selected parasitic element parameter to the reference parasitic element parameter; and repeating the calculation, the selection and the expression using the ratio for the one equipotential net for all the equipotential nets existing in the interconnect pattern.

According to the present invention, for achievement of worst-case simulation and best-case simulation, a parasitic element extraction result is first obtained using an interconnect pattern giving the maximum or minimum capacitance as a reference, and a resistance value included in the obtained parasitic element extraction result is multiplied by a resistance coefficient, to perform condition-specific timing verification.

Specifically, the timing verification method of the present invention is a timing verification method for verifying operation timing of a semiconductor integrated circuit including a plurality of cells having logic function, terminals of the plurality of cells being connected to each other via interconnects, the method including the steps of: preparing in advance one capacitance library made out based on a previously defined interconnect structure giving a maximum or minimum capacitance; and in extraction of parasitic element parameters such as resistance and capacitance in an interconnect pattern comprising a plurality of equipotential nets for connecting terminals of the plurality of cells to each other equipotentially, calculating a parasitic element parameter using the one capacitance library prepared in advance for one equipotential net among the plurality of equipotential nets; then calculating a parasitic element parameter for another equipotential net by multiplying a resistance value included in the parasitic element parameter calculated previously by an arbitrary coefficient; and thereafter repeating the processing of multiplying a resistance value by an arbitrary coefficient for the remainder of the equipotential nets existing in the interconnect pattern.

According to the present invention, for achievement of worst-case simulation and best-case simulation, a parasitic element extraction result is first obtained using an interconnect pattern giving the maximum or minimum capacitance as a reference, and a capacitance value and resistance value included in the obtained parasitic element extraction result are multiplied by a capacitance coefficient and a resistance coefficient, respectively, to perform condition-specific timing verification.

Specifically, the timing verification method of the present invention is a timing verification method for verifying operation timing of a semiconductor integrated circuit including a plurality of cells having logic function, terminals of the plurality of cells being connected to each other via interconnects, the method including the steps of: preparing in advance one capacitance library made out based on a previously defined interconnect structure giving a maximum or minimum capacitance; and in extraction of parasitic element parameters such as resistance and capacitance in an interconnect pattern comprising a plurality of equipotential nets for connecting terminals of the plurality of cells to each other equipotentially, calculating a parasitic element parameter using the one capacitance library prepared in advance for one equipotential net among the plurality of equipotential nets; then determining whether the net length of another equipotential net is shorter or longer; calculating a parasitic element parameter for the another equipotential net by multiplying a resistance value included in the parasitic element parameter calculated previously by an arbitrary coefficient if the net length is shorter than a predetermined length, and calculating a parasitic element parameter for the another equipotential net by multiplying a capacitance value and a resistance value included in the parasitic element parameter calculated previously by respective arbitrary coefficients if the net length is longer than the predetermined length; and thereafter repeating the processing of the determination on whether the net length is longer or shorter and the multiplication by a coefficient for the remainder of the equipotential nets existing in the interconnect pattern.

In an embodiment of the timing verification method of the present invention, the determination on whether the net length is longer or shorter for an equipotential net includes determining that the net length is shorter when the ratio of an effective capacitance to a total interconnect capacitance obtained from the equipotential net is equal to or less than a predetermined ratio and is longer when the ratio exceeds the predetermined ratio.

The layout optimization method of the present invention is a layout optimization method for optimizing the layout of a semiconductor integrated circuit including a plurality of cells having logic function, terminals of the plurality of cells being connected to each other via interconnects, the method including the steps of: calculating parasitic element parameters such as resistance and capacitance of an interconnect pattern by the timing verification method described above, the interconnect pattern comprising a plurality of equipotential nets for connecting terminals of the plurality of cells to each other equipotentially; performing delay calculation and timing verification for the respective equipotential nets using the calculated parasitic element parameters; and correcting the interconnect pattern if a timing error is found as a result of the timing verification to solve the timing violation.

As described above, according to the present invention, parasitic element extraction for worst-case simulation and best-case simulation can be performed while considering causes of fabrication process variations, such as the interconnect width, the interlayer film thickness and the interconnect film thickness, which may occur inside an LSI chip. Therefore, highly accurate timing verification is ensured.

Also, according to the present invention, in addition to the effect described above that parasitic element extraction for worst-case simulation and best-case simulation can be performed while considering causes of fabrication process variations, such as the interconnect width, the interlayer film thickness and the interconnect film thickness, which may occur inside an LSI chip to enable highly accurate timing verification, parasitic element extraction results consistent with the interconnect network can be obtained even when a capacitance coupling exists between its own equipotential net and an adjacent equipotential net.

According to the present invention, a parasitic element parameter is obtained for one equipotential net using one capacitance library giving the maximum or minimum capacitance. For another equipotential net, a resistance value included in the obtained parasitic element parameter may only be multiplied by a resistance coefficient, to enable accurate timing verification of worst-case simulation and best-case simulation. Therefore, with no necessity of performing the parasitic element extraction processing a plurality of times, the processing time can be widely reduced.

In addition, according to the present invention, a parasitic element parameter is obtained for one equipotential net using one capacitance library giving the maximum or minimum capacitance. For another shorter equipotential net, a resistance value included in the obtained parasitic element parameter may only be multiplied by a resistance coefficient, while for another longer equipotential net, a capacitance value and resistance value included in the obtained parasitic element parameter may only be multiplied by a capacitance coefficient and a resistance coefficient, respectively. Thus, even for a longer equipotential net in which the interconnect resistance is dominant in interconnect delay, timing verification of worst-case simulation and best-case simulation can be performed accurately by calculating a proper capacitance value. Hence, with no necessity of performing the parasitic element extraction processing a plurality of times, the processing time can be widely reduced.

### BRIEF DESCRIPTION OF THE DRAWINGS

FIG. 1 is a flowchart illustrating a timing verification method of Embodiment 1 of the present invention.

FIG. 2 is a view illustrating a method of capacitance calculation in parasitic element extraction calculations.

FIGS. 3A to 3C are views illustrating capacitance libraries, in which FIG. 3A shows a case in which a single conductor exists, FIG. 3B shows cases in which two conductors exist, and FIG. 3C shows cases in which three conductors exist.

FIG. 4A is a view showing an example of interconnect net as a target of parasitic element extraction calculation in the timing verification method of Embodiment 1 of the present invention, and FIG. 4B is a view showing the obtained parasitic element extraction result.

FIG. 5 is a view showing a configuration of a timing verification apparatus that executes the timing verification method of Embodiment 1.

FIG. 6 is a flowchart illustrating a timing verification method of Embodiment 2 of the present invention.

FIG. 7A is a view showing an example of interconnect net as a target of parasitic element extraction calculation in the timing verification method of Embodiment 2, FIG. 7B is a view showing n parasitic element extraction results obtained using n capacitance libraries, and FIG. 7C is a view showing the finally-obtained parasitic element extraction result.

FIG. 8 is a view showing a configuration of a timing verification apparatus that executes the timing verification method of Embodiment 2.

FIG. 9 is a flowchart illustrating a timing verification method of Embodiment 3 of the present invention.

FIG. 10A is a view showing an example of interconnect net as a target of parasitic element extraction calculation in the timing verification method of Embodiment 3, FIG. 10B is a view showing n parasitic element extraction results obtained using n capacitance libraries, and FIG. 10C is a view showing the finally-obtained parasitic element extraction result.

FIG. 11 is a view showing a configuration of a timing verification apparatus that executes the timing verification method of Embodiment 3.

FIG. 12 is a flowchart illustrating a timing verification method of Embodiment 4 of the present invention.

FIG. 13A is a view showing an example of interconnect net as a target of parasitic element extraction calculation in the timing verification method of Embodiment 4, FIG. 13B is a view showing a reference interconnect network as the parasitic element extraction result obtained using the capacitance library giving the maximum capacitance, and FIG. 13C is a view showing a parasitic element extraction result for another interconnect net obtained using the reference interconnect network.

FIG. 14 is a view showing a configuration of a timing verification apparatus that executes the timing verification method of Embodiment 4.

FIG. 15 is a flowchart illustrating a timing verification method of Embodiment 5 of the present invention.

FIG. 16A is a view showing an example of interconnect net as a target of parasitic element extraction calculation in the timing verification method of Embodiment 5, FIG. 16B is a view showing a reference interconnect network as the parasitic element extraction result obtained using the capacitance library giving the maximum capacitance, and FIG. 16C is a view showing a parasitic element extraction result for an interconnect net having a short interconnect length obtained using the reference interconnect network.

FIG. 17 is a view showing a configuration of a timing verification apparatus that executes the timing verification method of Embodiment 5.

FIG. 18 is a flowchart illustrating a layout optimization method of Embodiment 6 of the present invention.

### DESCRIPTION OF THE PREFERRED EMBODIMENTS

Hereinafter, embodiments of the timing verification method according to the present invention will be described in detail with reference to the accompanying drawings. Note that while the present invention is applicable to both worst-case simulation and best-case simulation, the following description will be made taking the case of worst-case simulation as an example.

### EMBODIMENT 1

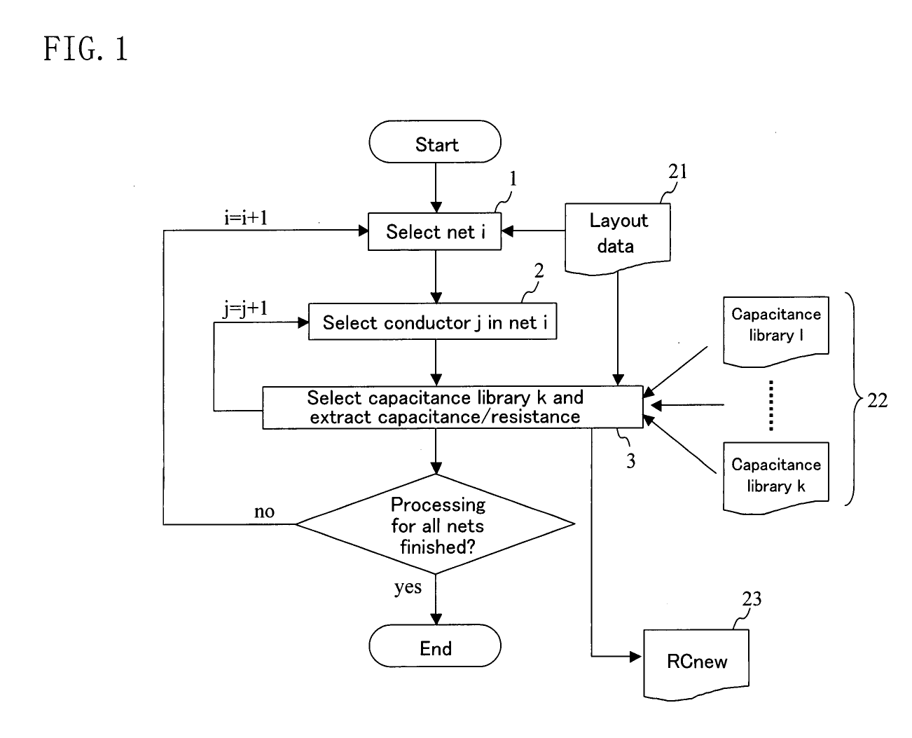

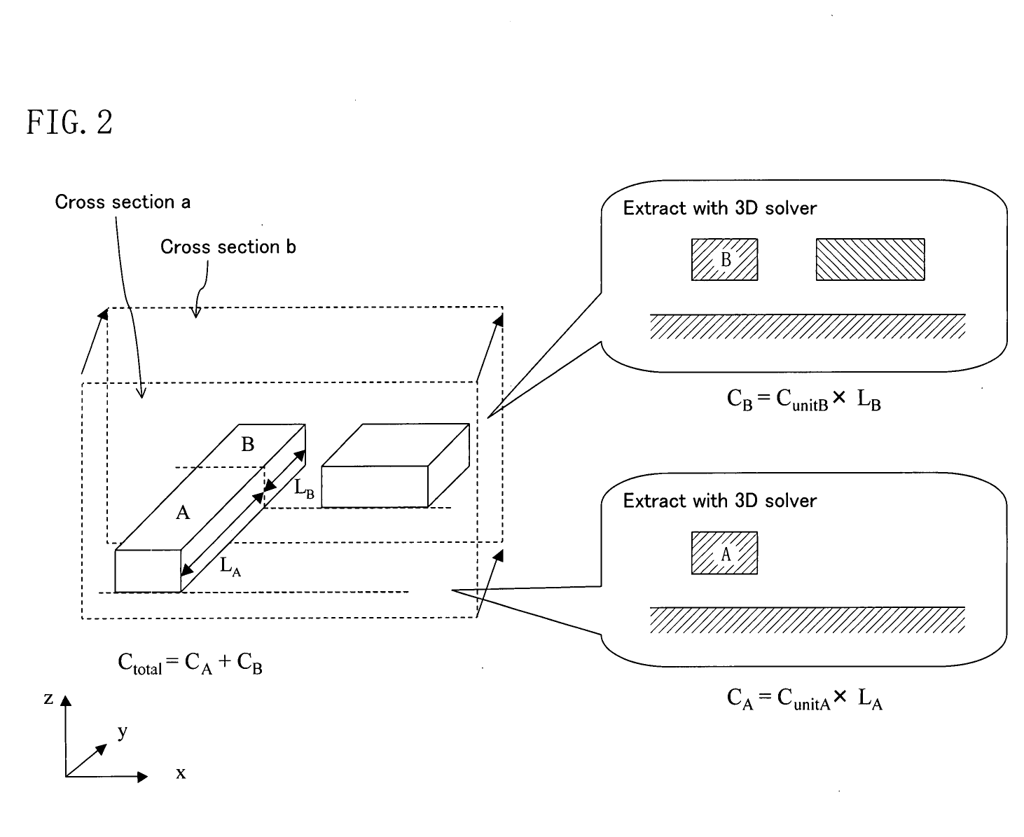

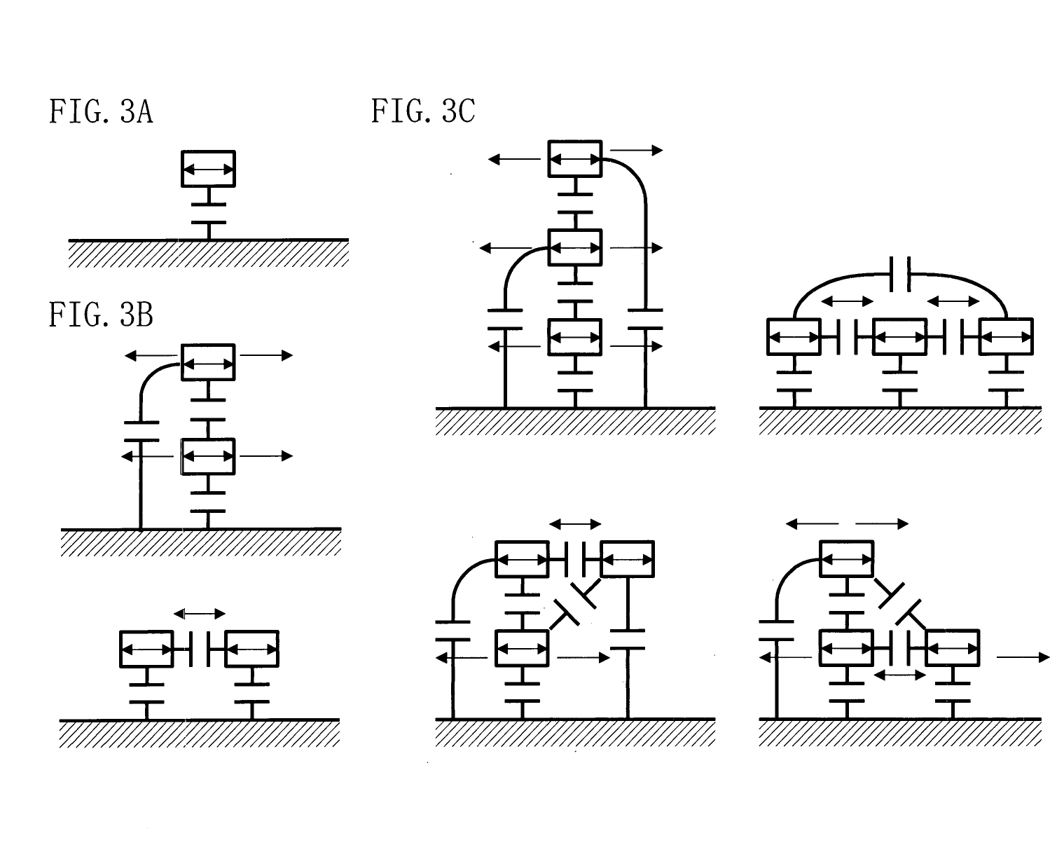

Embodiment 1 of the present invention will be described with reference to FIGS. 1 to 4. Referring to FIG. 1, block 1 is a step of selecting an interconnect net i (i is an arbitrary value from 1 to N (total number of interconnect nets)), block 2 is a step of selecting a conductor j (j is an arbitrary value from 1 to J (total number of conductors constituting the interconnect net)), and block 3 is a step of selecting a capacitance library k (k is an arbitrary number from 1 to K (total number of capacitance libraries)) and performing capacitance and resistance extraction. These steps are executed by computer. The capacitance library is an important concept in understanding the present invention. The capacitance libraries and a use method thereof will be described with reference to FIGS. 2 and 3.

FIG. 2 illustrates a basic technique of capacitance extraction in parasitic element extraction. There are two conductors in the view located left as is seen from FIG. 2. Suppose the capacitance of the conductor on the left is to be calculated. When viewing the left-side conductor in the y direction, it is found that one conductor is seen placed alone as shown in the lower-right view at and after a cross section a by a length LA, and that two conductors are seen placed side by side as shown in the upper-right view at and after a cross section b by a length LB. The capacitance of the left-side conductor is roughly Ctotal=CA+CB. Therefore, the respective segment capacitances CA and CB should be obtained. As shown in the lower-right view, assuming that the capacitance per unit length of segment A in its two-dimensional expression is CunitA, the segment capacitance CA can be obtained by multiplying CunitA by the length LA. Segment B has a conductor on its right side and is positioned side by side in parallel with this conductor. Assuming that the capacitance per unit length of the segment B in this state is CunitB, the segment capacitance CB can be obtained by multiplying CunitB by the length LB in a similar manner.

As is found from the above, the capacitance of the target conductor can be obtained by tracing the target conductor in the length direction, obtaining cross sections of the conductor including a conductor surrounding the target conductor, multiplying the capacitance per unit length obtained from each cross section by the length, and summing all the capacitances obtained. Therefore, the definition of a cross-sectional structure and the interconductor capacitance per unit length for the cross section should be determined in advance.

FIGS. 3A to 3C illustrate the placement of conductor or conductors in cross section and the inter-conductor capacitance per unit length to be obtained. FIG. 3A shows a case in which a single conductor exists. In this case, only the capacitance between the conductor and the ground is to be obtained. Note however that since the capacitance value varies with the size of the conductor (width of the conductor in the illustrated example), it is necessary to calculate in advance the capacitance value with the conductor size as a parameter. FIG. 3B shows cases in which two conductors exist. The conductors are placed side by side vertically in one case and horizontally in the other case. In both cases, it is necessary to calculate in advance the capacitance value with the inter-conductor distance and the width of each conductor as parameters for all combinations. FIG. 3C shows cases in which three conductors exist. Basically, as in the cases of FIG. 3B, it is necessary to calculate the capacitance value with the inter-conductor distance and the width of each conductor as parameters for all combinations. In these cases, however, the number of combinations is much larger than in the cases of FIG. 3B. In general, the number of combinations for which the capacitance value must be calculated increases exponentially with increase of the number of conductors to be considered. Limitations are therefore normally placed. Only two or so conductors in the upper, lower, right and left sides of the target conductor may be considered.

The capacitance library as used herein refers to a set of combinations as shown in FIGS. 3A to 3C prepared as a library. Considering the fabrication process variations for which the present invention is meant, and assuming that the interconnect width, the interlayer film thickness and the interconnect film thickness vary, for example, the third power of 2 (=8) types of capacitance libraries are prepared in advance.

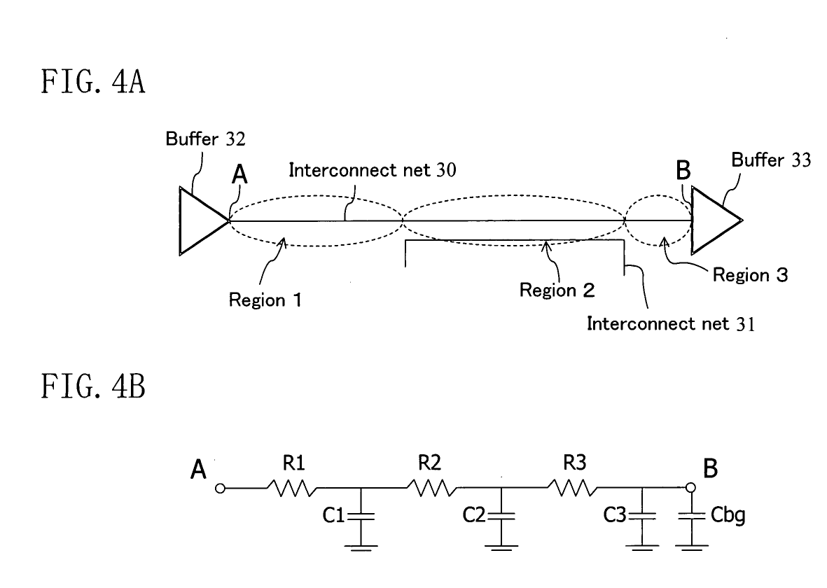

FIG. 4A illustrates a circuit in which buffers 32 and 33 are connected to each other via an interconnect net 30 as an equipotential net. In the semiconductor integrated circuits to which the present invention is applicable, a plurality of cells having logic function are placed and terminals of these cells are connected to one another via interconnects. Herein, for simplification of description, a case as shown in FIG. 4A in which two buffers (cells) 32 and 33 are connected to each other via the interconnect net 30 will be described. In FIG. 4A, part of the interconnect net 30 adjoins an interconnect net 31.

Next, the timing verification method of this embodiment will be described. In FIG. 1, first in the step 1, an interconnect net i is selected for layout data 21. In FIG. 4A, the interconnect net 30 corresponds to the interconnect net i. The process then proceeds to the step 2. As shown in FIG. 4A, the interconnect net 30 is regarded as having three regions, region 1, region 2 and region 3. The reason of this division into regions is as described above with reference to FIG. 2. The region 1 includes only the interconnect net 30. In the step 2, each of these divided conductors is selected. In the step 3, a capacitance library that may give the worst-case simulation in the given situation is found out. Assume herein that the worst-case simulation is obtained when the resistance×capacitance is the maximum. The steps 2 and 3 are executed for all conductors in one interconnect net. Once the capacitance and the resistance have been calculated for all conductors in one interconnect net, the calculation result is stored in parasitic element extraction results 23. FIG. 4B shows the result.

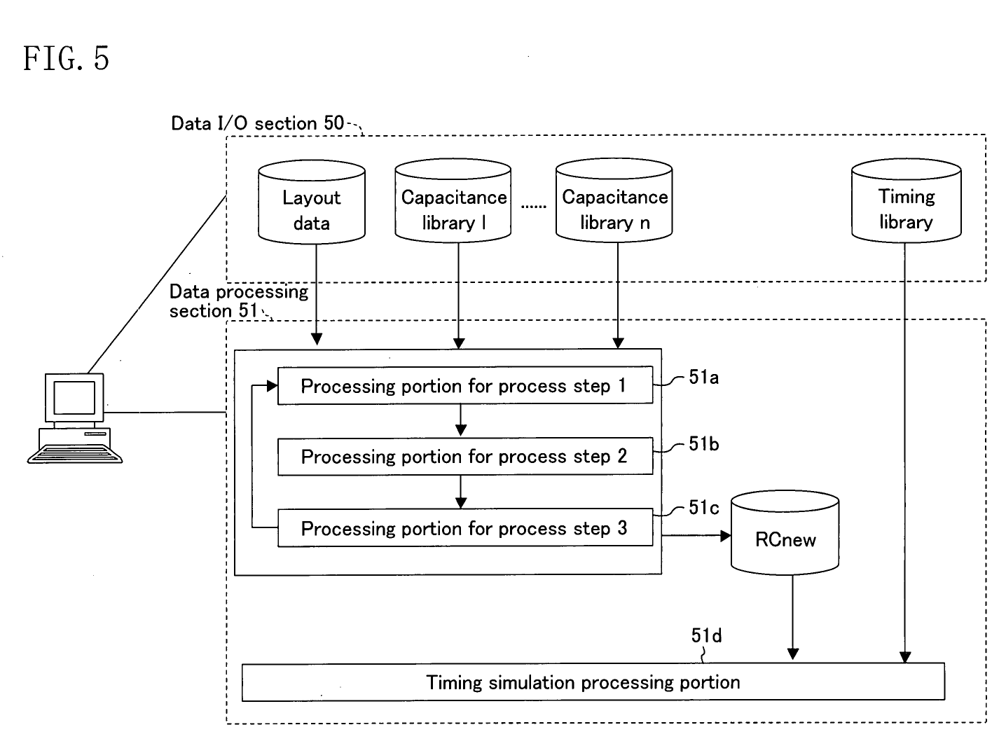

FIG. 5 shows the entire configuration of a timing verification apparatus that executes the timing verification method of this embodiment. In FIG. 5, n (n=8) capacitance libraries and a timing library are stored in advance in a data input/output (I/O) section 50. A data processing section 51 includes processing portions 51a, 51b and 51c respectively executing the process steps 1, 2 and 3 shown in FIG. 1 and a timing simulation processing portion 51d.

As described above, in this embodiment, one capacitance library that may give the worst-case (or best-case) simulation is selected among the eight capacitance libraries prepared for three parameters of fabrication process variations, i.e., the interconnect width, the interlayer film thickness and the interconnect film thickness, for example, for each conductor in one interconnect net. Hence, timing verification considering process variations correctly can be attained.

### EMBODIMENT 2

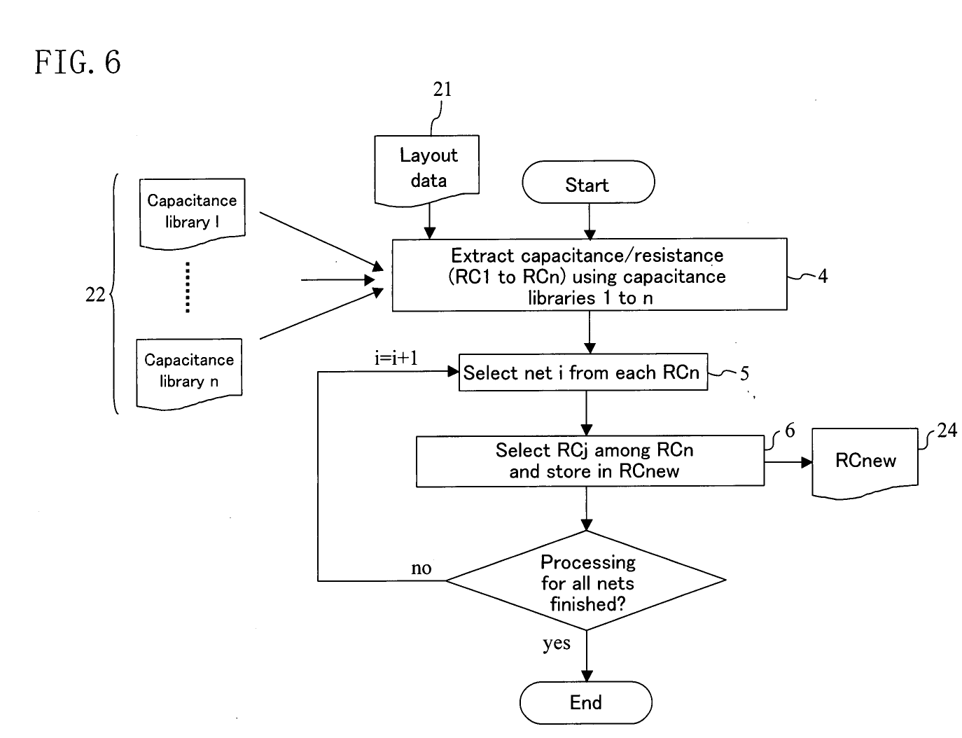

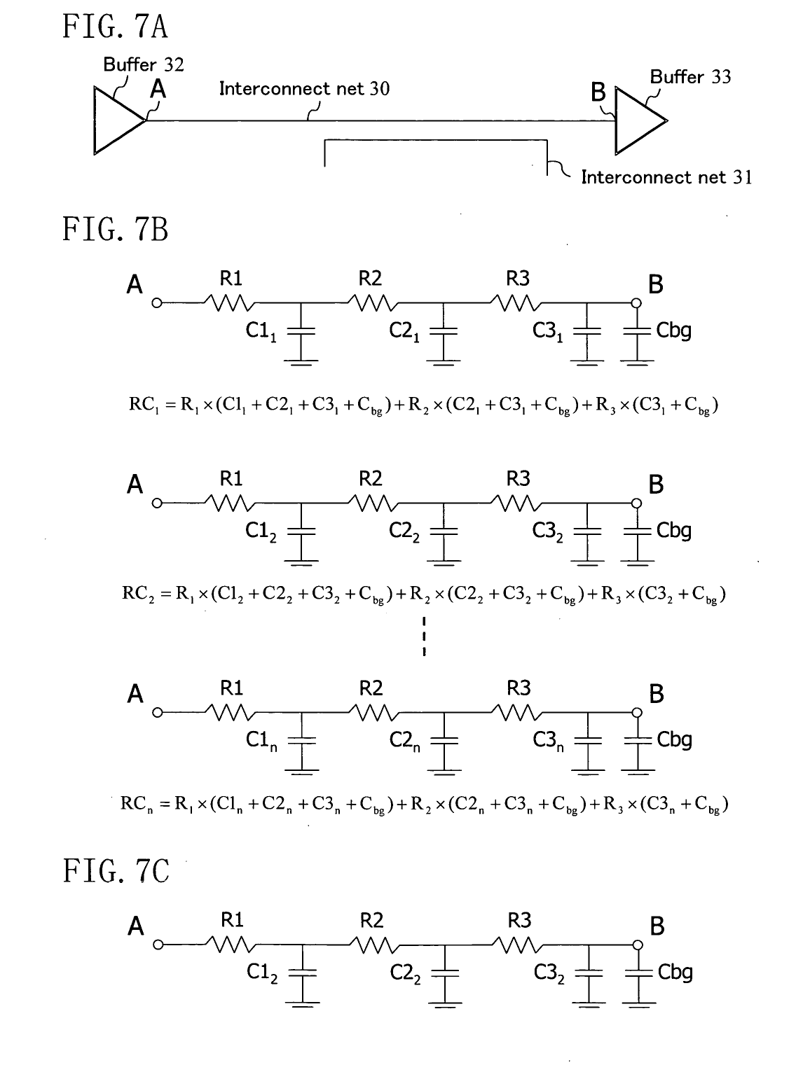

Embodiment 2 of the present invention will be described with reference to FIGS. 6 and 7.

Referring to FIG. 6, block 4 is a step of extracting parasitic elements using a plurality of capacitance libraries (n in this embodiment), block 5 is a step of selecting an interconnect net i, and block 6 is a step of selecting one resistance/capacitance network among resistance/capacitance networks for the interconnect net i. FIG. 7A is substantially the same as FIG. 4A.

In FIG. 6, first, a plurality of capacitance libraries are prepared using fabrication process variations as parameters. In this embodiment, assume that n capacitance libraries are prepared. In the step 4, all the capacitance libraries are applied to each of all units of layout data 21. Since n capacitance libraries are applied to one layout data unit, n parasitic element extraction results can be resultantly obtained for each interconnect net. In the step 5, the interconnect net i is selected. Unlike Embodiment 1, no division into regions is necessary in this embodiment. Instead, the parasitic element extraction results have been obtained using the plurality of capacitance libraries in the step 4.

FIG. 7B shows the parasitic element extraction results obtained from the capacitance libraries 1 to n. In the step 6, an interconnect network that will give the worst-case simulation is found out. In this embodiment, also, assume that the worst-case simulation is obtained when the resistance×capacitance is the maximum. In FIG. 7B, calculation of the capacitance and resistance RC1 to RCn is also shown. This calculation is based on a first-order approximation calculation scheme called Elmore delay. This calculation scheme is described in Journal of Applied Physics, 1948, pp.55-63. Assuming that the maximum value is RC2, the result of the capacitance library 2 is adopted as shown in FIG. 7C. The steps 5 and 6 are executed for all interconnect nets. A selected capacitance and resistance network for each interconnect net is stored in the capacitance element extraction results 24.

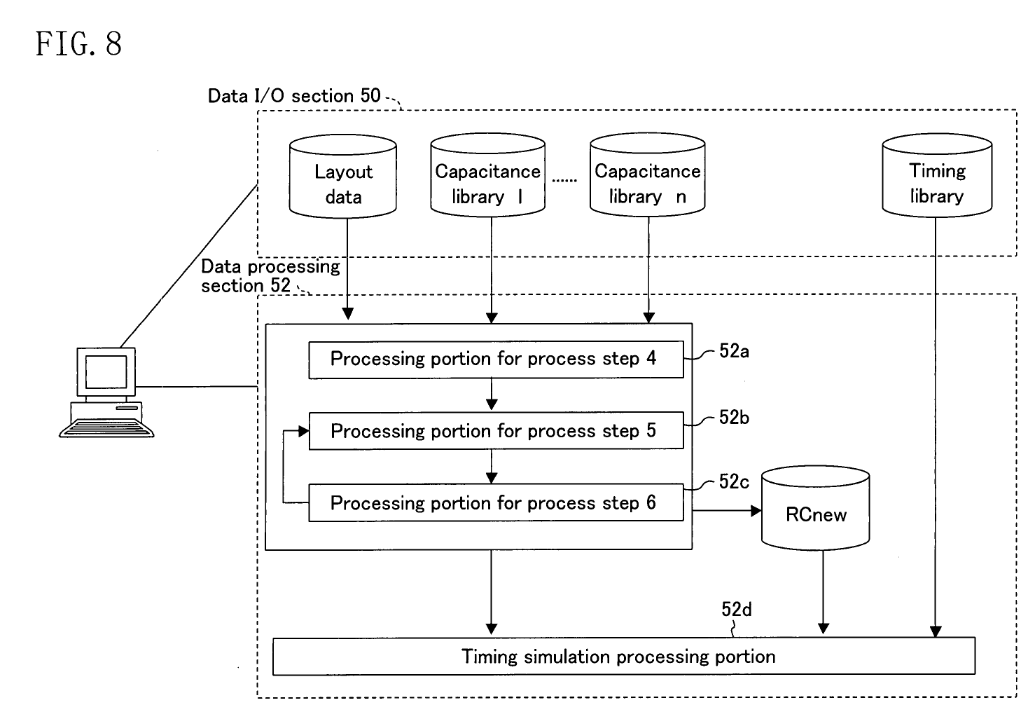

FIG. 8 shows the entire configuration of a timing verification apparatus that executes the timing verification method of this embodiment. In FIG. 8, a data processing section 52 includes processing portions 52a, 52b and 52c respectively executing the process steps 4, 5 and 6 shown in FIG. 6 and a timing simulation processing portion 52d.

As described above, in this embodiment, one parasitic element extraction result that may give the worst-case (or best-case) simulation is selected among the parasitic element extraction results obtained using a plurality of capacitance libraries for each interconnect net. Hence, timing verification considering process variations correctly can be attained.

### EMBODIMENT 3

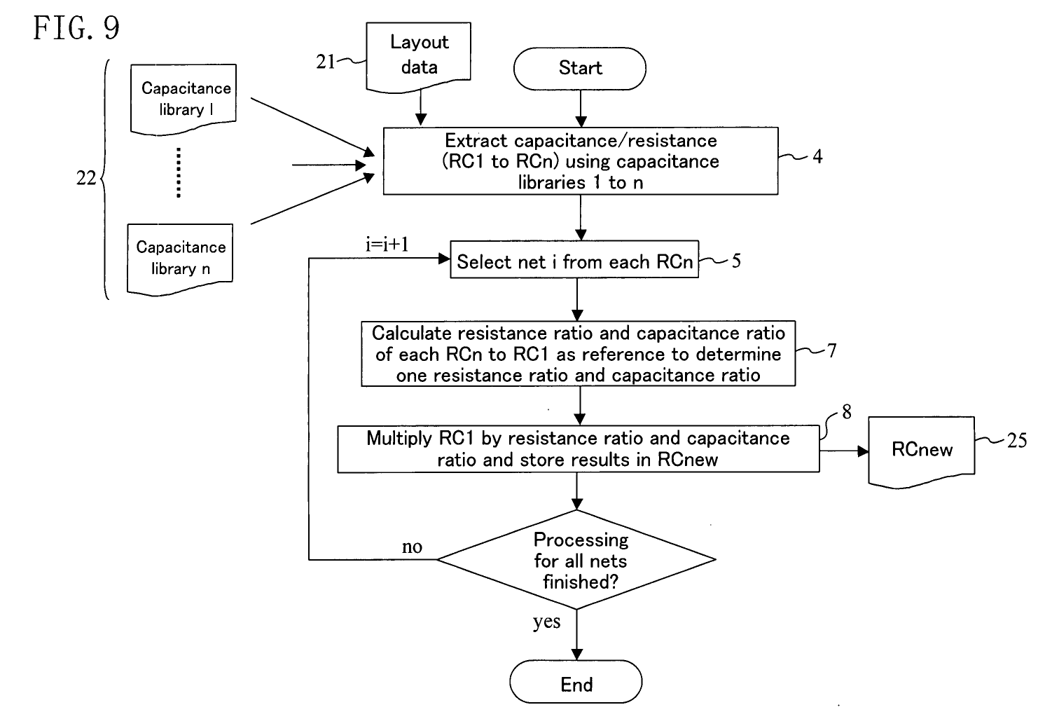

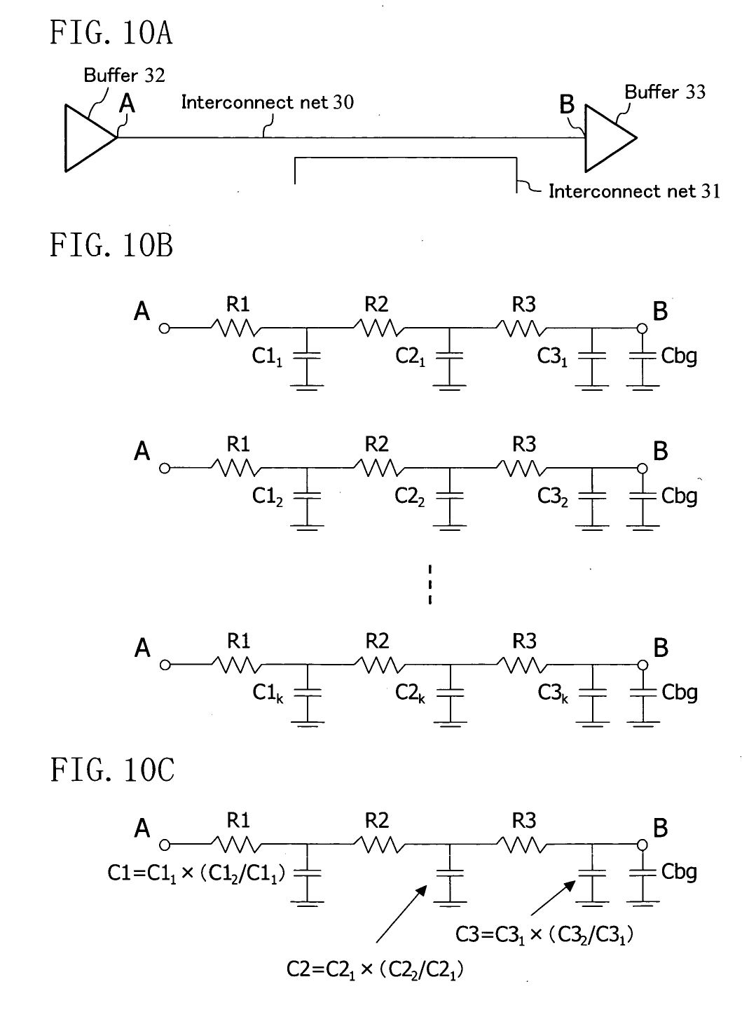

Embodiment 3 of the present invention will be described with reference to FIGS. 9 and 10.

Referring to FIG. 9, block 7 is a step of calculating the ratios of the resistance and capacitance to those in a parasitic element extraction result obtained from a reference capacitance library, and block 8 is a step of multiplying the parasitic element extraction result obtained from the reference capacitance library by the ratios obtained in the step 7. FIG. 10A is substantially the same as FIG. 4A.

In FIG. 9, first, one capacitance library is selected arbitrarily (in the illustrated example, the capacitance library 1 is selected), and the parasitic element extraction result obtained from the selected capacitance library 1 is determined as a reference interconnect network (reference parasitic element parameter).

The steps 4 and 5 are the same as in Embodiment 2. The step 7 is basically the same in operation as the step 6, but is different in the following point. In the step 7, after an interconnect network to be used for worst-case simulation is found out, the capacitance ratio and resistance ratio with respect to the reference interconnect network are obtained so that the capacitance value and resistance value of the found interconnect network can be substituted into the reference interconnect network. As shown in FIG. 10C, the parasitic element extraction result obtained from the capacitance library 1 is multiplied by the ratio of the parasitic element extraction result obtained from the capacitance library 2 to the parasitic element extraction result obtained from the capacitance library 1. With this operation, the result obtained from the capacitance library 2 can be used only in the capacitance value and the resistance value while the topology of the reference interconnect network is maintained.

The above operation may become necessary in extraction of an interconnect resistance and capacitance network including coupling capacitance. In general, different capacitance libraries have different interconnect resistance and capacitance networks. Expressing a coupling capacitance involves referring to a resistance and capacitance network node name in another interconnect net. However, whether or not such a node name exists is unlikely to be known over different capacitance libraries. Thus, to maintain the interconnect topology, the method of this embodiment is useful.

The steps 7 and 8 are executed for all interconnect nets. A selected capacitance and resistance network for each interconnect net is stored in the capacitance element extraction results 25.

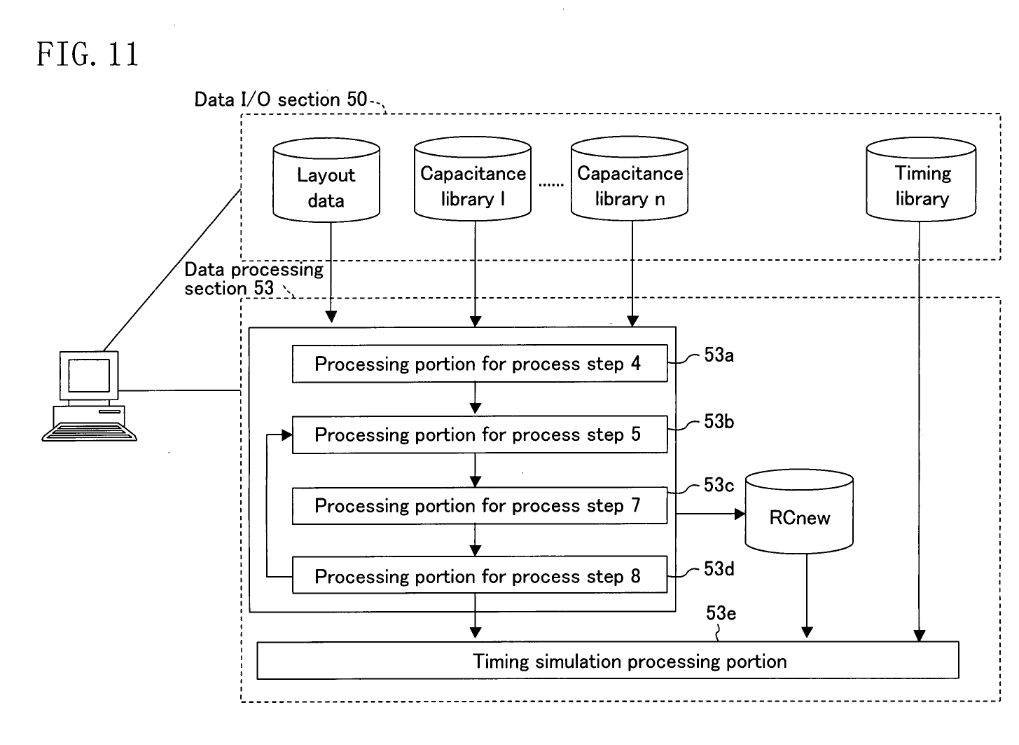

FIG. 11 shows the entire configuration of a timing verification apparatus that executes the timing verification method of this embodiment. In FIG. 11, a data processing section 53 includes processing portions 53a, 53b, 53c and 53d respectively executing the process steps 4, 5, 7 and 8 shown in FIG. 9 and a timing simulation processing portion 53e.

As described above, in this embodiment, one parasitic element extraction result that may give the worst-case (or best-case) simulation is selected among parasitic element extraction results obtained from a plurality of capacitance libraries for each interconnect net. In addition, the topology of the interconnect network can be maintained. Hence, timing verification considering fabrication process variations correctly can be attained.

### EMBODIMENT 4

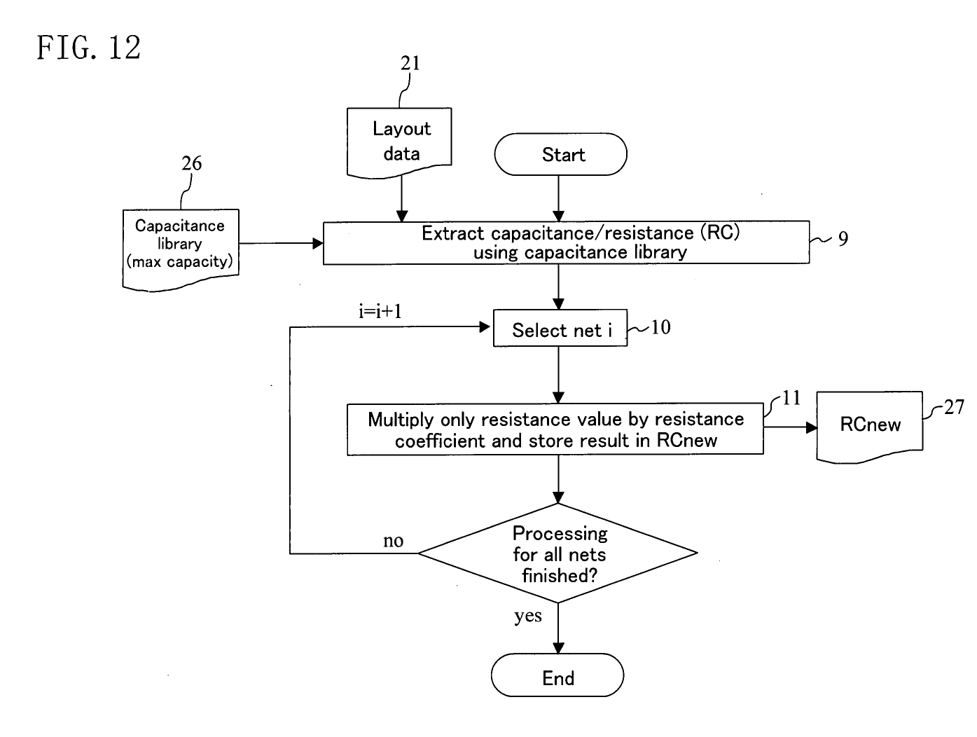

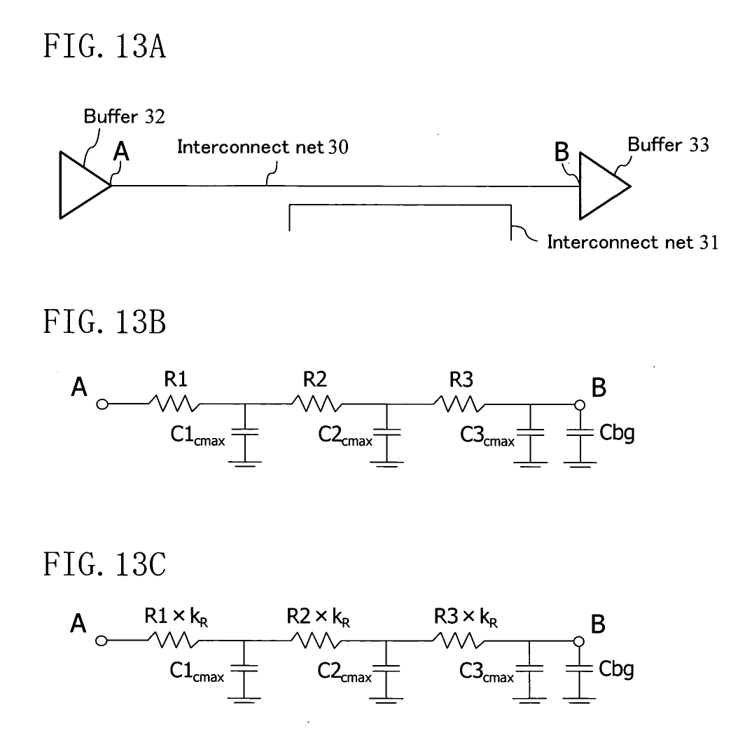

Embodiment 4 of the present invention will be described with reference to FIGS. 12 and 13.

Referring to FIG. 12, block 9 is a step of performing parasitic element extraction using a capacitance library that may give the maximum capacitance, block 10 is a step of selecting the interconnect net i, and block 11 is a step of multiplying the resistance value of the interconnect network obtained in the step 9 by a resistance coefficient. FIG. 13A is substantially the same as FIG. 4A.

In FIG. 12, first, one capacitance library that may give the maximum capacitance is determined arbitrarily (in the illustrated example, the capacitance library 1 is determined) and the parasitic element extraction result in one interconnect net applying the determined capacitance library is used as a reference interconnect network. The capacitance library giving the maximum capacitance refers to a capacitance library in the case that the interlayer film thickness is small, the interconnect film thickness is large and the interconnect width is large. By selecting this capacitance library, the capacitance value can be maximized. The result is assumed to be as shown in FIG. 13B.

The steps 10 and 11 are then repeated, multiplying the obtained resistance value by a resistance coefficient for all of the remaining interconnect nets. The resistance coefficient is an arbitrary value. For example, it is possible to calculate the resistance coefficient with respect to the capacitance being 1 with which the resistance×capacitance will be the maximum considering process variations. The result of the step 11 is shown in FIG. 13C in which the resistance coefficient is expressed by kR.

The steps 10 and 11 are executed for all interconnect nets. A selected capacitance and resistance network for each interconnect net is stored in the capacitance element extraction results 27.

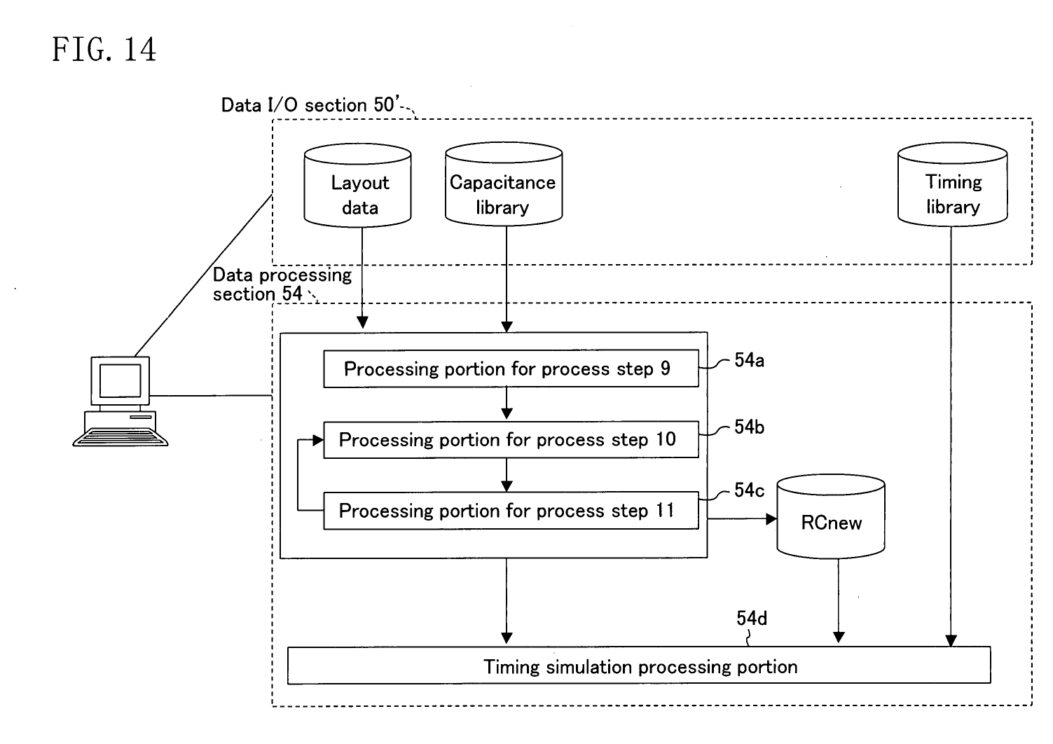

FIG. 14 shows the entire configuration of a timing verification apparatus that executes the timing verification method of this embodiment. In FIG. 14, one capacitance library giving the maximum capacitance and the timing library are stored in a data I/O section 50′. A data processing section 54 includes processing portions 54a, 54b and 54c respectively executing the process steps 9, 10 and 11 shown in FIG. 12 and a timing simulation processing portion 54d. Alternatively, in the data I/O section 50′, a plurality of capacitance libraries may be prepared in advance and one among the stored capacitance libraries may be selected as the capacitance library giving the maximum capacitance.

As described above, in this embodiment, timing verification of worst-case simulation and best-case simulation can be performed correctly by merely multiplying the resistance included in the result of the original interconnect network by a resistance coefficient, without obtaining parasitic element extraction results from a plurality of capacitance libraries prepared assuming fabrication process variations. Hence, with no necessity of performing the parasitic element extraction processing a plurality of times, the processing time can be widely reduced.

### EMBODIMENT 5

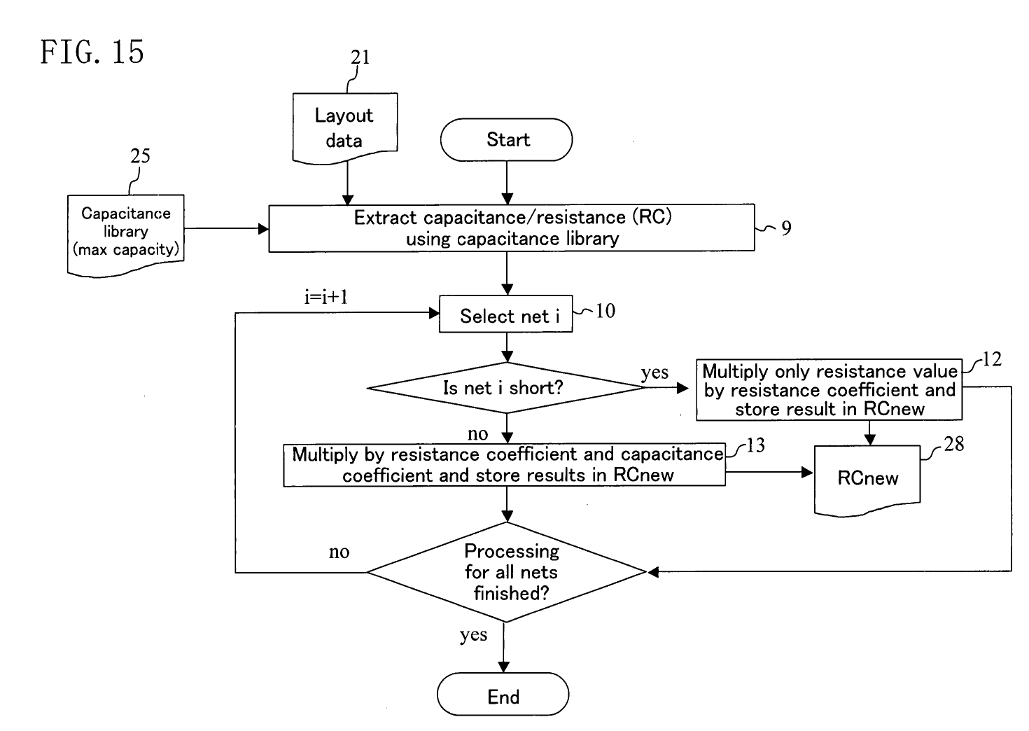

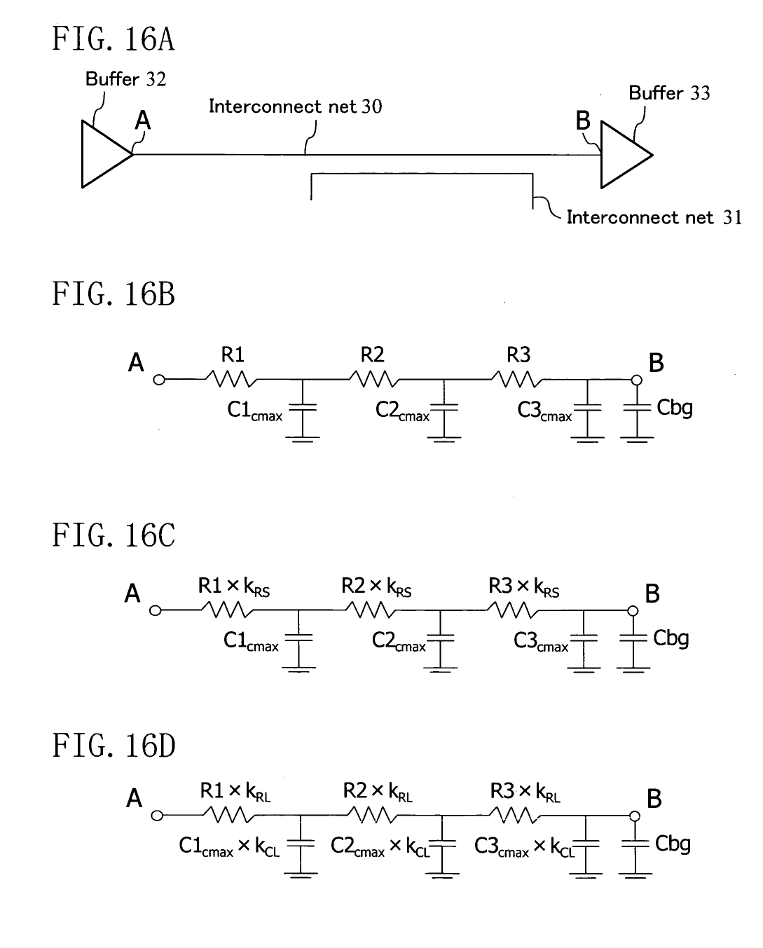

Embodiment 5 of the present invention will be described with reference to FIGS. 15 and 16.

Referring to FIG. 15, block 12 is a step of multiplying the resistance value in the interconnect net i obtained in the step 9 by a resistance coefficient, and block 13 is a step of multiplying the capacitance and the resistance by a capacitance coefficient and a resistance coefficient, respectively. FIG. 16A is substantially the same as FIG. 4A. The process is the same as that in Embodiment 4 up to the step 10, and the result up to the step 10 is assumed to be as shown in FIG. 16B.

Thereafter, whether the selected interconnect net i is an interconnect longer or shorter than a predetermined length is determined. In a shorter interconnect, the interconnect capacitance is considered dominant in the interconnect delay, and thus the resistance may be multiplied by a predetermined resistance coefficient kRS as shown in FIG. 16C. Meanwhile, in a longer interconnect, the interconnect resistance is considered dominant in the interconnect delay. Therefore, a resistance coefficient kRL different from the resistance coefficient kRS and also a capacitance coefficient kCL are calculated in advance as shown in FIG. 16D. The reason for calculating the capacitance coefficient is as follows. The interconnect resistance is large when the cross section of the interconnect is small, that is, when the interconnect capacitance is small. Hence, the capacitance value obtained using the capacitance library that may give the maximum capacitance will be different from that in the real physical situation. It is therefore necessary to multiply the capacitance value by the capacitance coefficient for correction. Although strictly the capacitance coefficient is presumably different among the interconnect nets, it is considered uniform in this embodiment. The present invention is also applicable to the case of calculating the capacitance coefficient for each interconnect net. In this case, however, the processing time will be great.

The length of the interconnect may be determined by comparing the total interconnect capacitance with the effective capacitance. The total interconnect capacitance refers to the sum of only the capacitance values among the resistance and capacitance constituting the interconnect network and the input pin capacitance of the next-stage transistor. The effective capacitance refers to the value expressed only by the capacitance to be equal to the delay time calculated in the resistance and capacitance network. When the interconnect resistance is not so influential over the interconnect delay, the total interconnect capacitance and the effective capacitance are roughly equal to each other. With increase of the influence of the interconnect resistance, a difference arises between the total interconnect capacitance and the effective capacitance. In this embodiment, it is assumed that the interconnect net is determined to be a long interconnect net if the ratio of the total interconnect capacitance to the effective capacitance exceeds a predetermined ratio, for example, if a difference exceeding 10% arises between the two capacitances. The predetermined ratio can be set arbitrarily.

The steps 12 and 13 are executed for all interconnect nets. A selected capacitance and resistance network for each interconnect net is stored in the capacitance element extraction results 28.

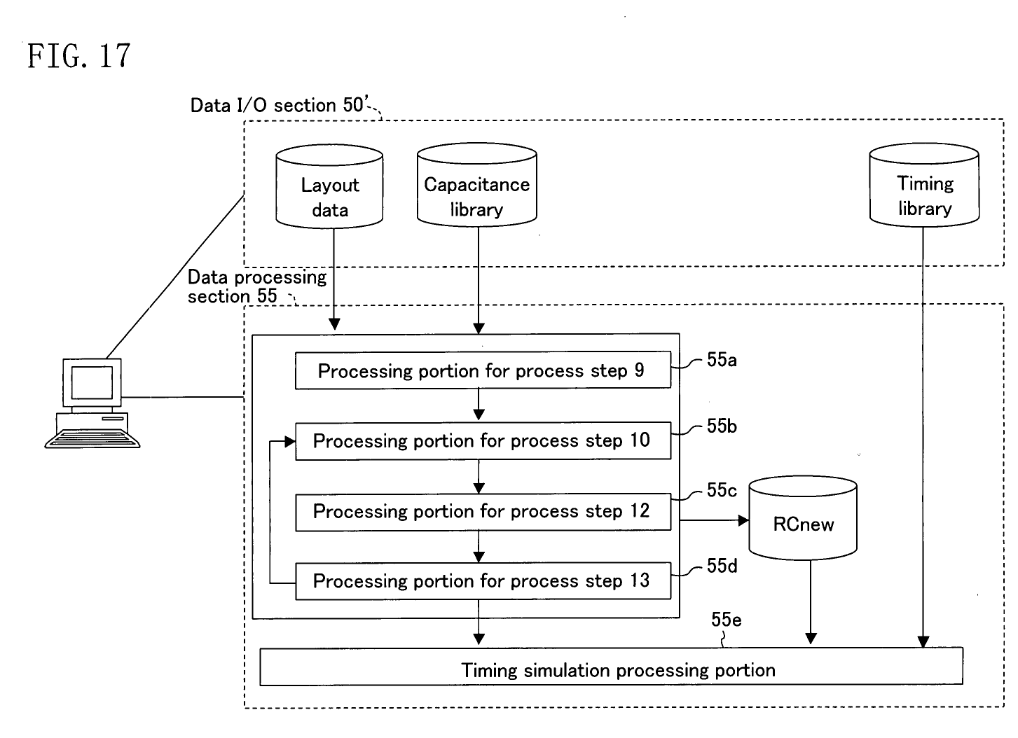

FIG. 17 shows the entire configuration of a timing verification apparatus that executes the timing verification method of this embodiment. In FIG. 17, one capacitance library giving the maximum capacitance and the timing library are stored in the data I/O section 50′. A data processing section 55 includes processing portions 55a, 55b, 55c and 55d respectively executing the process steps 9, 10, 12 and 13 shown in FIG. 15 and a timing simulation processing portion 55e.

As described above, in this embodiment, timing verification of worst-case simulation and best-case simulation can be performed correctly by only multiplying the resistance and capacitance values in the result of the original interconnect network by a resistance coefficient and a capacitance coefficient, respectively, without obtaining parasitic element extraction results from a plurality of capacitance libraries prepared assuming fabrication process variations. Hence, with no necessity of performing the parasitic element extraction processing a plurality of times, the processing time can be widely reduced.

In the above description, the types of interconnect nets are classified by differentiating resistance-dominant interconnects in which delay is determined mainly with a resistance component from capacitance-dominant interconnects in which delay is determined mainly with a capacitance component. This technique is conventionally known and disclosed in C. Cheng, J. Lillis, S. Lin and N. Chang, “Interconnect Analysis and Synthesis” (Chapter 3.6 Effective Capacitance Model), for example.

In Embodiments 4 and 5, the capacitance library giving the maximum capacitance was used as the capacitance library to be prepared in advance. Contrarily, a capacitance library giving the minimum capacitance may be prepared. Otherwise, one capacitance library giving the maximum or minimum resistance value may be prepared in advance.

### EMBODIMENT 6

Embodiment 6 of the present invention will be described.

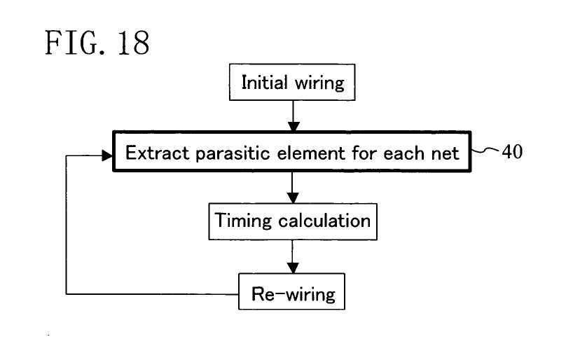

FIG. 18 shows wiring optimization processing employing any one of the methods of Embodiments 1 to 5 in an LSI layout design process. The wiring optimization processing in the LSI layout design process includes four steps; initial wiring processing, parasitic element extraction processing, timing calculation processing and re-wiring processing. The present invention is applied to the parasitic element extraction processing.

In FIG. 18, step 40 of performing parasitic element extraction processing for each interconnect net is provided between the initial wiring step and the timing calculation step. The parasitic element extraction processing in any of Embodiments 1 to 5 is adopted for the step 40. In the timing calculation step, the timing is verified using parasitic element parameters for each interconnect net obtained in the preceding parasitic element extraction step 40. If a timing error is found as a result of the timing verification, the relevant interconnect net is corrected in the re-wiring step to solve the timing violation.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A timing verification method for verifying operation timing of a semiconductor integrated circuit including a plurality of cells having logic function, terminals of the plurality of cells being connected to each other via interconnects, the method comprising the steps of:
preparing in advance a plurality of capacitance libraries made out based on a plurality of previously defined interconnect structures; and
in extraction of parasitic element parameters such as resistance and capacitance in an interconnect pattern comprising a plurality of equipotential nets for connecting terminals of the plurality of cells to each other equipotentially,
repeating calculating a parasitic element parameter for each of a plurality of conductors constituting one of the plurality of equipotential nets by selecting one of the plurality of capacitance libraries according to the state of another interconnect surrounding each conductor of the equipotential net; and
repeating the calculation of the parasitic element parameter for each conductor of the one equipotential net for all the equipotential nets existing in the interconnect pattern.

2. A timing verification method for verifying operation timing of a semiconductor integrated circuit including a plurality of cells having logic function, terminals of the plurality of cells being connected to each other via interconnects, the method comprising the steps of:
preparing in advance a plurality of capacitance libraries made out based on a plurality of previously defined interconnect structures; and
in extraction of parasitic element parameters such as resistance and capacitance in an interconnect pattern comprising a plurality of equipotential nets for connecting terminals of the plurality of cells to each other equipotentially,
calculating a parasitic element parameter using each of the plurality of capacitance libraries for one of the plurality of equipotential nets;
selecting one of the plurality of calculated parasitic element parameters; and
repeating the calculation and selection of the parasitic element parameters for one equipotential net for all the equipotential nets existing in the interconnect pattern.

3. A timing verification method for verifying operation timing of a semiconductor integrated circuit including a plurality of cells having logic function, terminals of the plurality of cells being connected to each other via interconnects, the method comprising the steps of:
preparing in advance a plurality of capacitance libraries made out based on a plurality of previously defined interconnect structures; and
in extraction of parasitic element parameters such as resistance and capacitance in an interconnect pattern comprising a plurality of equipotential nets for connecting terminals of the plurality of cells to each other equipotentially,
selecting one capacitance library among the plurality of capacitance libraries and calculating a parasitic element parameter using the selected capacitance library for one equipotential net selected from the plurality of equipotential nets to use the calculated parasitic element parameter as a reference parasitic element parameter;
calculating parasitic element parameters using capacitance libraries other than the selected one capacitance library for the selected one equipotential net;
selecting one of the plurality of parasitic element parameters calculated using the other capacitance libraries, and expressing the selected parasitic element parameter using the ratio of the selected parasitic element parameter to the reference parasitic element parameter; and
repeating the calculation, the selection and the expression using the ratio for the one equipotential net for all the equipotential nets existing in the interconnect pattern.

4. A timing verification method for verifying operation timing of a semiconductor integrated circuit including a plurality of cells having logic function, terminals of the plurality of cells being connected to each other via interconnects, the method comprising the steps of:
preparing in advance one capacitance library made out based on a previously defined interconnect structure giving a maximum or minimum capacitance; and
in extraction of parasitic element parameters such as resistance and capacitance in an interconnect pattern comprising a plurality of equipotential nets for connecting terminals of the plurality of cells to each other equipotentially,
calculating a parasitic element parameter using the one capacitance library prepared in advance for one equipotential net among the plurality of equipotential nets;
then calculating a parasitic element parameter for another equipotential net by multiplying a resistance value included in the parasitic element parameter calculated previously by an arbitrary coefficient; and
thereafter repeating the processing of multiplying a resistance value by an arbitrary coefficient for the remainder of the equipotential nets existing in the interconnect pattern.

5. A timing verification method for verifying operation timing of a semiconductor integrated circuit including a plurality of cells having logic function, terminals of the plurality of cells being connected to each other via interconnects, the method comprising the steps of:
preparing in advance one capacitance library made out based on a previously defined interconnect structure giving a maximum or minimum capacitance; and
in extraction of parasitic element parameters such as resistance and capacitance in an interconnect pattern comprising a plurality of equipotential nets for connecting terminals of the plurality of cells to each other equipotentially,
calculating a parasitic element parameter using the one capacitance library prepared in advance for one equipotential net among the plurality of equipotential nets;
then determining whether the net length of another equipotential net is shorter or longer;
calculating a parasitic element parameter for the another equipotential net by multiplying a resistance value included in the parasitic element parameter calculated previously by an arbitrary coefficient if the net length is shorter than a predetermined length, and calculating a parasitic element parameter for the another equipotential net by multiplying a capacitance value and a resistance value included in the parasitic element parameter calculated previously by respective arbitrary coefficients if the net length is longer than the predetermined length; and
thereafter repeating the processing of the determination on whether the net length is longer or shorter and the multiplication by a coefficient for the remainder of the equipotential nets existing in the interconnect pattern.

6. The timing verification method of claim 5, wherein the determination on whether the net length is longer or shorter for an equipotential net includes determining that the net length is shorter when the ratio of an effective capacitance to a total interconnect capacitance obtained from the equipotential net is equal to or less than a predetermined ratio and is longer when the ratio exceeds the predetermined ratio.

7. A layout optimization method for optimizing the layout of a semiconductor integrated circuit including a plurality of cells having logic function, terminals of the plurality of cells being connected to each other via interconnects, the method comprising the steps of:
calculating parasitic element parameters such as resistance and capacitance of an interconnect pattern by the timing verification method of claim 1, the interconnect pattern comprising a plurality of equipotential nets for connecting terminals of the plurality of cells to each other equipotentially;
performing delay calculation and timing verification for the respective equipotential nets using the calculated parasitic element parameters; and
correcting the interconnect pattern if a timing error is found as a result of the timing verification to solve the timing violation.

8. A layout optimization method for optimizing the layout of a semiconductor integrated circuit including a plurality of cells having logic function, terminals of the plurality of cells being connected to each other via interconnects, the method comprising the steps of:
calculating parasitic element parameters such as resistance and capacitance of an interconnect pattern by the timing verification method of claim 2, the interconnect pattern comprising a plurality of equipotential nets for connecting terminals of the plurality of cells to each other equipotentially;
performing delay calculation and timing verification for the respective equipotential nets using the calculated parasitic element parameters; and
correcting the interconnect pattern if a timing error is found as a result of the timing verification to solve the timing violation.

9. A layout optimization method for optimizing the layout of a semiconductor integrated circuit including a plurality of cells having logic function, terminals of the plurality of cells being connected to each other via interconnects, the method comprising the steps of:
calculating parasitic element parameters such as resistance and capacitance of an interconnect pattern by the timing verification method of claim 3, the interconnect pattern comprising a plurality of equipotential nets for connecting terminals of the plurality of cells to each other equipotentially;
performing delay calculation and timing verification for the respective equipotential nets using the calculated parasitic element parameters; and
correcting the interconnect pattern if a timing error is found as a result of the timing verification to solve the timing violation.

10. A layout optimization method for optimizing the layout of a semiconductor integrated circuit including a plurality of cells having logic function, terminals of the plurality of cells being connected to each other via interconnects, the method comprising the steps of:
calculating parasitic element parameters such as resistance and capacitance of an interconnect pattern by the timing verification method of claim 4, the interconnect pattern comprising a plurality of equipotential nets for connecting terminals of the plurality of cells to each other equipotentially;
performing delay calculation and timing verification for the respective equipotential nets using the calculated parasitic element parameters; and
correcting the interconnect pattern if a timing error is found as a result of the timing verification to solve the timing violation.

11. A layout optimization method for optimizing the layout of a semiconductor integrated circuit including a plurality of cells having logic function, terminals of the plurality of cells being connected to each other via interconnects, the method comprising the steps of:
calculating parasitic element parameters such as resistance and capacitance of an interconnect pattern by the timing verification method of claim 5, the interconnect pattern comprising a plurality of equipotential nets for connecting terminals of the plurality of cells to each other equipotentially;
performing delay calculation and timing verification for the respective equipotential nets using the calculated parasitic element parameters; and
correcting the interconnect pattern if a timing error is found as a result of the timing verification to solve the timing violation.
